(19) United States
(12) Patent Application Publication
(10) Pub. No.: US 2024/0211309 A1
(43) Pub. Date: Jun. 27, 2024

(54) MULTI-LEVEL SCHEDULING FOR IMPROVED QUALITY OF SERVICE

(71) Applicants: ATI TECHNOLOGIES ULC, MARKHAM (CA); ADVANCED MICRO DEVICES, INC., SANTA CLARA, CA (US)

(72) Inventors: Ahmed M. Abdelkhalek, Ajax (CA); Rutao Zhang, Markham (CA); Min Zhang, King City (CA); Yinan Jiang, Richmond Hill (CA); Jeffrey G. Cheng, Toronto (CA); Yuping Shen, Oviedo, FL (US); Mikhail Mironov, Richmond Hill (CA)

(21) Appl. No.: 18/085,902

(22) Filed: Dec. 21, 2022

(51) Int. Cl. G06F 9/48; G06F 9/455

(52) U.S. Cl. CPC G06F 9/4887; G06F 9/45558; G06F 2009/4557

(57) ABSTRACT

A parallel processor is configured to enforce job limits for virtual functions to facilitate an expected quality of service for each of the virtual functions assigned to a virtual machine executing at the processing unit. A scheduler schedules well-behaving virtual functions prior to badly-behaving virtual functions to prevent badly-behaving virtual functions from consuming a disproportionate share of hardware resources, thereby mitigating an impact of the badly-behaving virtual functions on the quality of service of the well-behaving virtual functions.

### BACKGROUND

Conventional processing units such as graphics processing units (GPUs) support virtualization that allows multiple virtual machines (VMs) to use the hardware resources of the GPU. Some VMs implement an operating system that allows the VM to emulate a physical machine. Other VMs are designed to execute code in a platform-independent environment. A hypervisor creates and runs VMs, which are also referred to as guest machines or guests. The virtual environment implemented on the GPU also provides virtual functions to other virtual components implemented on a physical machine. A single physical function implemented in the GPU is used to support one or more virtual functions (VFs). The physical function allocates the virtual functions to different VMs on the physical machine on a time-sliced or time-partitioned basis. For example, the physical function allocates a first virtual function to a first VM in a first time interval and a second virtual function to a second VM in a second, subsequent time interval. The single root input/output virtualization (SR-IOV) specification allows multiple VMs to share a GPU interface to a single bus, such as a peripheral component interconnect express (PCIe) bus. Components access the virtual functions by transmitting requests over the bus.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is an exemplary block diagram of a processing system configured to enforce job limits for virtual functions, in accordance with some embodiments.

FIG. 2 is an exemplary block diagram of a mapping of virtual functions to virtual machines implemented in a processing unit, in accordance with some embodiments.

FIG. 3 is an exemplary block diagram of a scheduler module, in accordance with some embodiments.

FIG. 4 is an exemplary block diagram of time partitioning that supports fair access to virtual machines associated with virtual functions in a processing unit, in accordance with some embodiments.

FIG. 5 is an exemplary diagram showing cadence and job sizes for various jobs submitted for execution by a plurality of virtual functions, in accordance with some embodiments.

FIG. 6 is a flow diagram of an exemplary method of scheduling first and second virtual functions, in accordance with some embodiments.

### DETAILED DESCRIPTION

The hardware resources of a GPU are partitioned according to SR-IOV using a physical function (PF) and one or more virtual functions (VFs). Each virtual function is associated with a single physical function. In a native (host OS) environment, a physical function is used by native user mode and kernel-mode drivers and all virtual functions are disabled. All the GPU registers are assigned to the physical function via trusted access. In a virtual environment, the physical function is used by a hypervisor (host VM) and the GPU exposes a certain number of virtual functions as per the PCIe SR-IOV standard, such as one virtual function per guest VM. Each virtual function is assigned to the guest VM by the hypervisor.

Typically, central processing units (CPUs) are partitioned across virtual functions, such that each virtual function has dedicated CPUs. The CPU prepares and submits jobs to the GPU for the virtual function. Each virtual function receives remote user input and prepares job submissions based on the remote user input and may also submit jobs orthogonal to user input. The CPU may submit jobs to the GPU for the virtual function at any time; however, execution of the jobs on the GPU occurs during a time partition assigned to the virtual function. In many cases in which the jobs submitted by a virtual function are for streaming video, a virtual function will submit jobs to be executed at a regular cadence to achieve a target frames-per-second (FPS) rate. Consistent submission of single or multiple units of work that collectively correspond to “jobs” of similar sizes results in a regular cadence for job execution.

However, because the jobs are submitted based on the CPU preparation timing, the jobs may not align with the GPU time partition assigned to the virtual function. Additionally, jobs submitted by the plurality of virtual functions may vary in size, such that the time that each job takes to complete execution is longer than the assigned time partition. Further, in some instances a virtual function acts in a greedy or malicious manner by submitting an excessive number of jobs (or jobs that collectively take a longer time to execute) within an assigned time partition, thereby not submitting jobs within an expected cadence.

When a virtual function behaves in a greedy or malicious manner, the virtual function consumes a disproportionate share of hardware resources, which negatively impacts a quality of service for the other virtual functions assigned to the VM. The impact on virtual functions is based on both throughput and latency in some embodiments. Throughput refers to the job execution rate, which in some cases relates to one or more of an encoding resolution and frame rate, a video decoding rate, or a rendering rate for desktop or game frames experienced by each virtual function. Latency refers to the time between submission of a job to the GPU until the job completes execution at the GPU such that the job results may be consumed within an expected latency. For example, in the context of video encoding, latency refers to the time a job takes to complete so an encoded frame can be streamed.

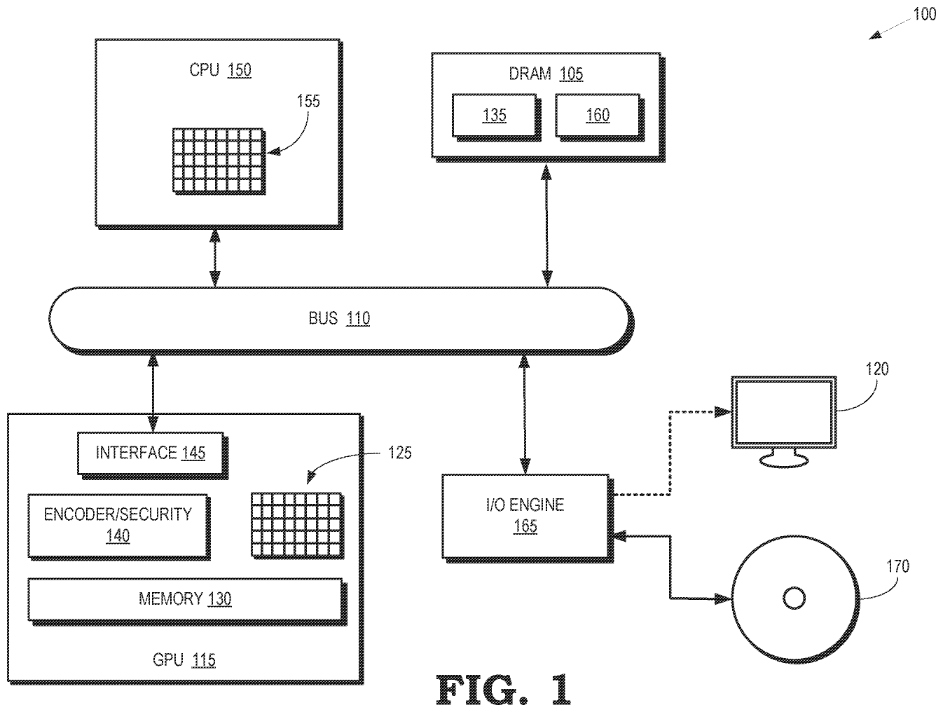

FIGS. 1-5 disclose embodiments of a processing unit, such as a graphics processing unit (GPU), of a processing system or server configured to enforce job limits for virtual functions to facilitate an expected quality of service for each of the virtual functions assigned to a VM executing at the processing unit. Scheduler module circuitry defines a scheduling period as the sum of per-virtual function time partitions plus an additional period of time referred to herein as “slack time”. Slack time allows for occasional variances in the cadence at which each virtual function submits jobs for execution by the GPU. For example, if a frame takes longer than expected to render, a virtual function could miss the opportunity to submit the frame during its allotted time slice and could submit the frame during the next allotted time slice along with the subsequent frame, resulting in a first time slice in which the virtual function submits no jobs and a second time slice in which the virtual function submits a batch of two jobs. Such occasional variances in the cadence of job submissions are expected and are not indicative of greedy or malicious behavior on the part of the virtual function. The GPU defines the per-virtual function time partition as an expected job size for the virtual function times N, where N is a number equal to or greater than 1 and depends on the GPU's tolerance to job submission behavior variance.

The GPU monitors jobs submitted for execution by virtual functions within a scheduling period to determine if the jobs are being submitted within an expected cadence, or frequency. The GPU further monitors whether the submitted jobs take longer to execute than an expected job size. The individual virtual functions are designated as being either well-behaving or badly-behaving, depending on whether the individual virtual functions submit jobs at the expected cadence and depending upon whether the submitted jobs that take longer to execute than the expected job size. A GPU scheduler schedules the well-behaving virtual function prior to the badly-behaving virtual function to prevent badly-behaving virtual functions from consuming a disproportionate share of hardware resources, thereby mitigating an impact of the badly-behaving virtual functions on the quality of service of the well-behaving virtual functions.

FIG. 1 is a block diagram of a processing system 100 configured to enforce job limits for virtual functions in accordance with some embodiments. The techniques described herein are, in different embodiments, employed at any of a variety of parallel processors, such as vector processors, graphics processing units (GPUs), general-purpose GPUs (GPGPUs), non-scalar processors, highly-parallel processors, artificial intelligence (AI) processors, inference engines, machine learning processors, other multithreaded processing units, and the like. FIG. 1 illustrates an example of a parallel processor, and in particular a graphics processing unit (GPU) 115 (e.g., a virtual GPU), in accordance with some embodiments. However, reference to a GPU herein will be understood to include any of a variety of parallel processors unless otherwise noted.

The processing system 100 includes or has access to a memory 105 or other storage component that is implemented using a non-transitory computer readable medium such as a dynamic random-access memory (DRAM). However, the memory 105 can also be implemented using other types of memory including static random-access memory (SRAM), nonvolatile RAM, and the like. The processing system 100 also includes a bus 110 to support communication between entities implemented in the processing system 100, such as the memory 105. In the illustrated embodiment, the bus 110 is configured as a PCIe bus. Some embodiments of the processing system 100 include other buses, bridges, switches, routers, and the like, which are not shown in FIG. 1 in the interest of clarity.

The processing system 100 also includes a central processing unit (CPU) 150 that is connected to the bus 110 and communicates with the GPU 115 and the memory 105 via the bus 110. In the illustrated embodiment, the CPU 150 implements multiple processing elements (also referred to as processor cores) 155 that are configured to execute instructions concurrently or in parallel. The CPU 150 executes instructions such as program code 160 stored in the memory 105 and the CPU 150 stores information in the memory 105 such as the results of the executed instructions. The CPU 150 initiates graphics processing by issuing draw calls to the GPU 115.

An input/output (I/O) engine 165 handles input or output operations associated with a display 120, as well as other elements of the processing system 100 such as keyboards, mice, printers, external disks, network, and the like. The I/O engine 165 is coupled to the bus 110 so that the I/O engine 165 communicates with the memory 105, the GPU 115, or the CPU 150. In the illustrated embodiment, the I/O engine 165 is configured to read information stored on an external storage component 170, which is implemented using a non-transitory computer readable medium such as a flash drive and the like. The I/O engine 165 can also write information to the external storage component 170, such as the results of processing by the GPU 115 or the CPU 150. The display 120 can be remotely connected to a VM through network connection with appropriate protocols.

The processing system 100 includes one or more graphics processing units (GPUs) 115 that are configured to render images for presentation on a display 120. For example, the GPU 115 can render objects to produce values of pixels that are provided to the display 120, which uses the pixel values to display an image that represents the rendered objects. The GPU 115 includes a GPU core 125 that is made up of a set of compute units, a set of fixed function units, or a combination thereof for executing instructions concurrently or in parallel. The GPU core 125 can include tens, hundreds, or even thousands of compute units or fixed function units for executing instructions.

The GPU 115 includes an internal (or on-chip) memory 130 that includes a frame buffer and a local data store (LDS), as well as caches, registers, or other buffers utilized by the compute units in the GPU core 125. The internal memory 130 stores data structures that describe tasks executing on one or more of the compute units or fixed function units in the GPU core 125. The compute units or fixed function units in the GPU core 125 are also able to access information in the (external) memory 105. In the illustrated embodiment, the GPU 115 communicates with the memory 105 over the bus 110. However, some embodiments of the GPU 115 communicate with the memory 105 over a direct connection or via other buses, bridges, switches, routers, and the like. The GPU 115 executes instructions stored in the memory 105 and the GPU 115 stores information in the memory 105 such as the results of the executed instructions. For example, the memory 105 can store a copy 135 of instructions from a program code that is to be executed by the GPU 115 such as program code that represents a shader, a virtual function, or other code that is executed by one or the compute units or fixed function units implemented in the GPU core 125.

The GPU 115 includes an encoder 140 that is used to encode information for transmission over the bus 110. The encoder 140 also provides security functionality to support secure communication over the bus 110. In some embodiments, the encoder 140 encodes values of pixels for transmission to the display 120, which implements a decoder to decode the pixel values to reconstruct the image for presentation. The display 120 can be remotely connected to a VM via a network connection. Some embodiments of the encoder 140 encode and encrypt information generated by the virtual functions implemented on the GPU 115 for communication via the bus 110.

Some embodiments of the GPU 115 operate as a physical function that supports one or more virtual functions that are shared over the bus 110. For example, the GPU 115 can use dedicated portions of the bus 110 to securely share a number of VMs using SR-IOV standards defined for a PCIe bus. The GPU 115 includes a bus interface 145 that provides an interface between the GPU 115 and the bus 110, e.g., according to the SR-IOV standards. The bus interface 145 provides functions including doorbell detection, register redirection, frame buffer apertures, doorbell write redirection, as well as other functions as discussed below.

As discussed in more detail below, at least one of a plurality of virtual functions, supported and enabled by the GPU 115, can submit jobs for execution that exceed their expected usage of the plurality of virtual functions, respectively. As an example, the jobs submitted for execution by the virtual functions are video encoding jobs. In some embodiments, the video encoding jobs encode video information for gaming applications being executed by the VM, such as gaming applications executed by a cloud gaming platform. A game may be expected to execute at a maximum frames per second (fps) and a maximum resolution. In order to prevent jobs submitted for execution by at least one of a plurality of virtual functions from exceeding their expected usage of the plurality of virtual functions, the GPU 115 includes a scheduler that prevents jobs from being executed for virtual functions that exceed their expected usage or are expected to exceed their expected usage, prior to executing jobs for virtual functions that have not exceeded their expected usage or are expected not to exceed their expected usage. In some embodiments, the virtual functions further may each include a scheduler that limits job submissions.

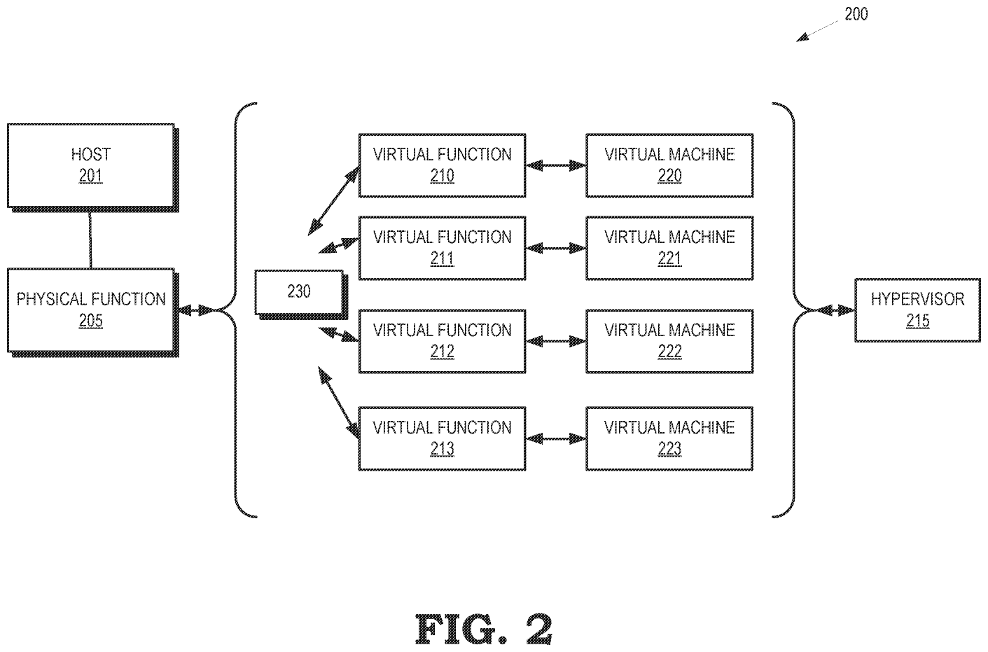

FIG. 2 is a block diagram of a mapping 200 of virtual functions to VMs implemented in a processing unit according to some embodiments. The mapping 200 represents a mapping of virtual functions to VMs implemented in some embodiments of the GPU 115 shown in FIG. 1. A host machine 201 includes a physical function 205 such as the GPU 115 that is partitioned into virtual functions 210, 211, 212, 213 during initialization of the physical function 205. In some embodiments, each of the virtual functions 210-213 includes an application (e.g., a video game), an application programming interface (API), a user mode driver (UMD), and a kernel mode driver (KMD). The host machine 201 implements a host operating system or a hypervisor 215 for the physical function 205. The hypervisor 215 launches one or more VMs 220, 221, 222, 223 for execution on a physical resource such as the GPU 115 that supports the physical function 205. In some embodiments, the VMs 220-223 include a GPU virtualization driver (GPUV) that can receive configuration information (e.g., from a server administrator, and pass the configuration information to virtual GPU components and virtual video cores or virtual engines (e.g., video core next (VCN)) that are assigned to each of the virtual functions 210-213.

The VMs 220-223 are assigned to a corresponding virtual function 210-213. In the illustrated embodiment, the VM 220 is assigned to the virtual function 210, the VM 221 is assigned to the virtual function 211, the VM 222 is assigned to the virtual function 212, and the VM 223 is assigned to the virtual function 213. The virtual functions 210-213 submit jobs to the GPU 115 which provides GPU functionality to the corresponding VMs 220-223. The virtualized GPU 115 is therefore shared across many VMs 220-223. In some embodiments, time slicing, also known as time partitioning, and context switching are used to provide fair access to the GPU 115 by the virtual functions 210-213 such that each of the virtual functions 210-213 are assigned respective time partitions for execution of a plurality of jobs by the GPU 115.

The VMs further 220-223 each include scheduler module circuitry 230 that manages virtual function access to the GPU 115. In some embodiments, the GPU 115 includes the scheduler module circuitry 230. In some embodiments, the scheduler module circuitry 230 is an SR-IOV multimedia GPU scheduler, hardware and/or firmware schedulers. In some embodiments, the scheduler module circuitry 230 is implemented in various forms such as a processor, field programmable gate arrays (FPGAs), or other forms of circuitry. This GPU side enforcement by the scheduler module circuitry 230 for badly-behaving virtual functions is difficult to work around, providing security for such scheduling. The scheduler module circuitry 230 defines a time period or scheduling period in which jobs submitted by the VMs 220-223 may be executed by the GPU 115, respectively.

In some embodiments, the scheduler module circuitry 230 assigns time slices to each of the virtual functions 210-213 that are tolerant to submission behavior variance. In such embodiments, the scheduler module circuitry 230 can assign time partitions to each of the virtual functions 210-213 to be equal to an expected job size for a particular virtual function multiplied by n, where n is 1, 2, etc., depending on desired tolerance to variance in the submission of jobs to the plurality of virtual functions 210-213. For example, the four (4) virtual functions 210-213 can submit jobs for execution by the GPU 115 with a resolution of 1080p at 60 fps where each job is expected to be <3 ms. If n=2, the time partitioning assigned to each of the virtual functions 210-213 is equal to 6 ms, when n equals 2, with 2 jobs*3 ms/job=6 ms. In some embodiments, the scheduler module circuitry 230 supports configurable tolerance for various metrics (e.g., expected job size+/−tolerance). In some embodiments, at least one of the virtual functions 210-213 supports multiple streams (e.g., a single virtual function submits for execution 1 1080p 60 fps stream+1 720p 30 fps stream).

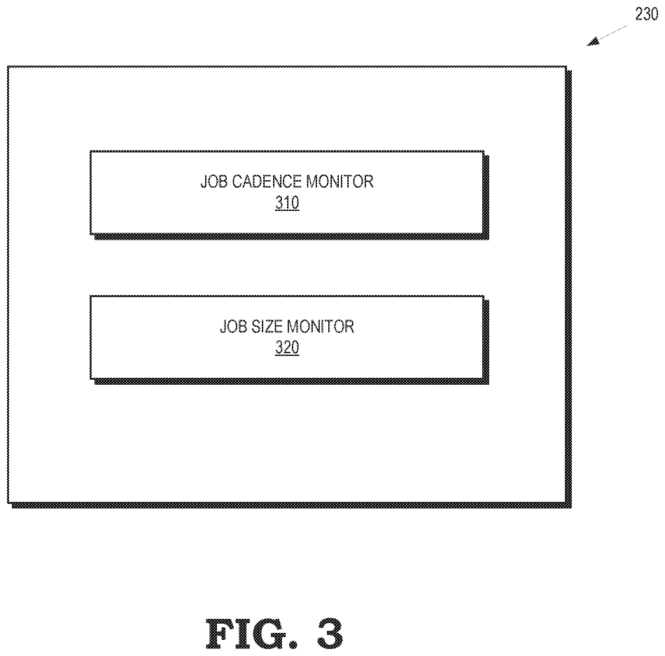

The scheduler module circuitry 230 includes job cadence monitor circuitry, referred to as job cadence monitor 310, and/or job size monitor circuitry, referred to as job size monitor 320, shown in FIG. 3. The job cadence monitor 310 monitors jobs submitted by the virtual functions 210-213 within a scheduling period to determine if the jobs are executing by the GPU 115 at an expected cadence having a time period between jobs submitted by the virtual functions being approximately equal from job to job by a particular virtual function. In some embodiments, the job cadence monitor 310 monitors whether an expected number of jobs is received within each scheduling period, as the time between job submissions is subject to variation due to submission jitter. The jobs size monitor 320 further monitors the sizes of jobs submitted by the virtual functions 210-213 for execution by the GPU 115 within each scheduling period. Based on monitoring by the job cadence monitor 310 and/or the job size monitor 320, the scheduler module circuitry 230 determines which of the virtual functions 210-213 are overutilizing an assigned virtual engine's bandwidth, such as the GPU 115, and time partitions, and which of the virtual functions 210-213 are not “badly-behaving”, are instead “well-behaving” in that they are not utilizing “more than it pays for” or not overutilizing an assigned virtual engine's bandwidth and time partitions. The scheduler module circuitry 230 schedules the virtual functions 210-213 based on at least in part on the determination of whether a virtual function is determined to be badly-behaving or well-behaving.

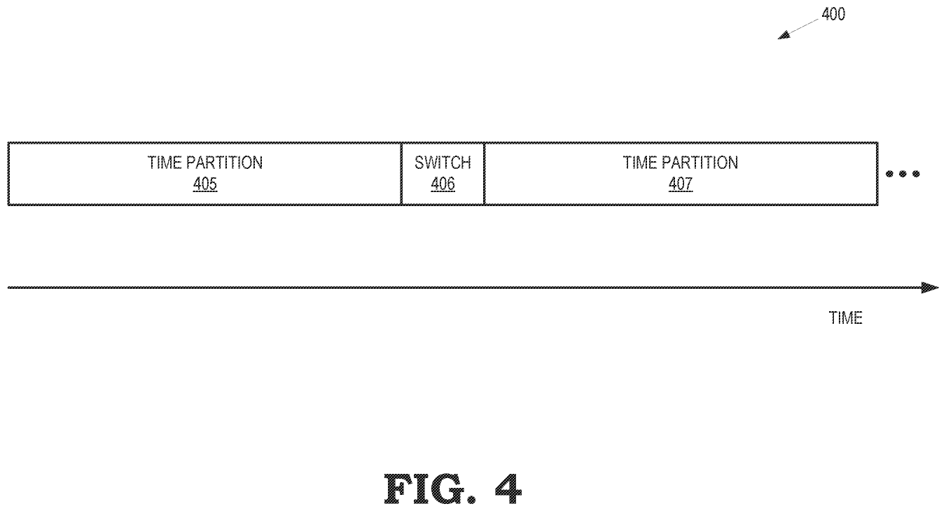

FIG. 4 is a block diagram of time partitioning 400 that supports fair access to virtual machines associated with virtual functions in a GPU 115 according to some embodiments. The time partitioning 400 is implemented in some embodiments of the GPU 115 shown in FIG. 1. The time partitioning 400 is used to provide fair access to some embodiments of the virtual machines 210-213 shown in FIG. 3. Time increases from left to right in FIG. 3. A first time partition 405 is allocated to a first virtual function, such as the virtual machine 220 that is assigned to the virtual function 210. State information for the virtual function 210 is stored by a bus interface such as the bus interface 145 shown in FIG. 1. Once the first time partition 405 is complete, the processing unit performs a context switch 406 that includes saving current context and state information for the first virtual function to a memory. The context switch 406 also includes retrieving context and state information for a second virtual function from the memory and loading the information into a memory or registers in the processing unit. The second time partition 407 is allocated to the second virtual function, which therefore has full access to the resources of the processing unit for the duration of the second time partition 407. The scheduler module circuitry 230 defines a scheduling period as a sum of these per-virtual function time partitions plus an additional period of time. These per-virtual function time partitions are periods in which an expected job size executes for the virtual function times N, where N is a number equal to or greater than 1 and depends on the GPU's tolerance to job submission behavior variance.

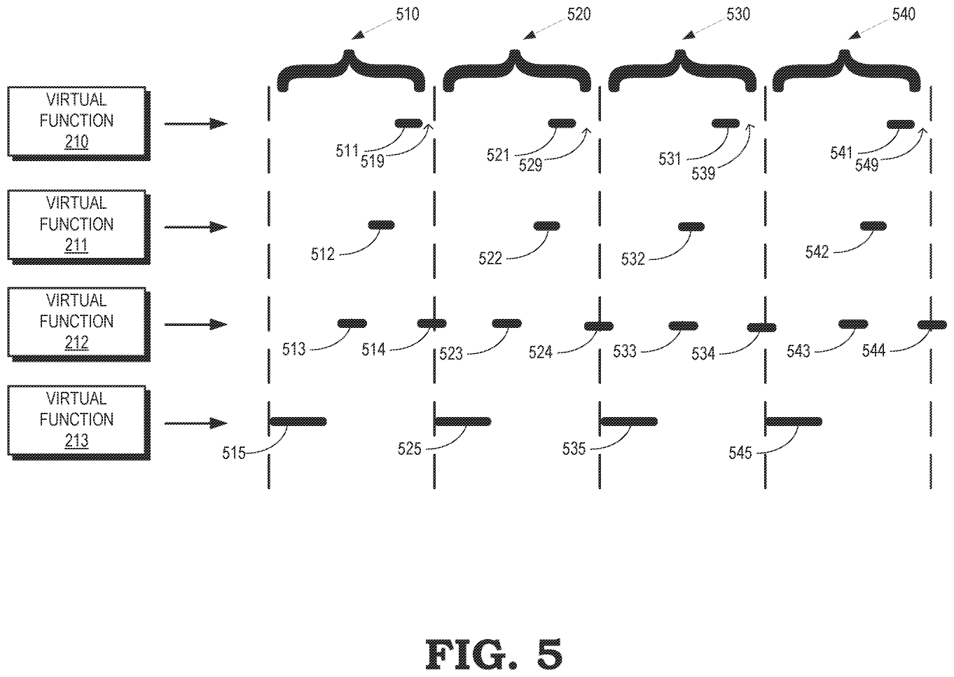

FIG. 5 is a diagram showing cadence and job sizes for various jobs submitted by a plurality of virtual functions for execution by the GPU 115. A plurality of time partitions are allocated to the virtual functions 210-213. These time partitions are allocated to virtual function 210 to submit the jobs 511, 521, 531, 541, virtual function 211 to submit the jobs 512, 522, 532, 542, virtual function 212 to submit the jobs 513, 514, 523, 524, 533, 534, 543, 544, and virtual function 213 to submit the jobs 515, 525, 535, 545. The job cadence monitor 310 determines that the plurality of jobs 511, 521, 531, 541 submitted for execution by the virtual function 210 are within the expected cadence and the plurality of jobs 512, 522, 532, 542 submitted for execution by the virtual function 211 are within the expected cadence. As shown, the jobs 511, 521, 531, 541, 512, 522, 532, 542 submitted by the virtual functions 210, 211, respectively, start at approximately a same time within each of the scheduling periods 510-540. Thus, the virtual functions 210, 211 each submit a single job at an expected cadence within each of the first, second, third, and fourth scheduling periods 510-540. As used herein, jobs “submitted” by the virtual functions 210-213 include not only jobs that in fact are executed by the GPU 115, but also include jobs that attempt to use a disproportionate share of bandwidth available by the GPU 115. In some embodiments, the virtual functions 210-213 submit jobs at substantially a same expected cadence. In other embodiments, the virtual functions 210-213 submit jobs at different cadences (e.g., some virtual functions submit jobs at 30 fps, and some virtual functions submit jobs at 60 fps).

In contrast to the jobs submitted by virtual functions 210, 211, the virtual function 212 is shown as submitting jobs more frequently than virtual functions 210, 211. Virtual function 212 is shown as submitting jobs 513, 514, 523, 524, 533, 534, 543, 544. Thus, virtual function 212 submits eight (8) jobs for execution within the four (4) scheduling periods 510, 520, 530, 540. With an expected cadence of four (4), the virtual function 212 submits for execution more than its fair share of jobs. The job cadence monitor 310 determines that virtual function 212 is submitting more jobs for execution than the expected number of jobs for execution for virtual function 212 and identifies virtual function 212 as badly-behaving. Also in contrast to jobs submitted by the virtual functions 210, 211, the virtual function 213 is shown as submitting jobs that are larger than an expected job size. Although virtual function 213 submits the four (4) jobs 515, 525, 535, 545 within the four (4) scheduling periods 510, 520, 530, 540, the size of the jobs submitted by the virtual function 213 are larger than the jobs submitted by virtual functions 210, 211, and larger than an expected job size. The jobs size monitor 320 determines that the virtual function 213 is submitting jobs for execution that are larger than an expected job size and identifies virtual function 213 as badly-behaving.

In some embodiments, the jobs submitted by virtual functions 210-213 are video encoding jobs, such as for a video game. Each of the virtual machines 220-223 can independently execute a video game. Based on the configuration of each of the video games, it is expected that each of the video games are to execute with a resolution of 1080p with a balanced encoding preset at 60 frames per second (fps). If all of the jobs submitted by the virtual functions 210-213 execute with a resolution of 1080p at 60 fps, the scheduler module circuitry 230 identifies all of the virtual functions 210-213 as well-behaving virtual functions. However, in some cases a virtual function consistently exceeds the expected job submission cadence and/or job size, such as when a malicious virtual function exploits open-source code (e.g., OpenGL) being executed by the virtual machines. As an example, jobs can be submitted for execution by a virtual function 210-213 more often than the expected fps (e.g., 120 fps vs. an expected 60 fps). The job cadence monitor 310 monitors the cadence of jobs submitted at a rate of 120 fps and identifies the virtual function 210-213 submitting the jobs as badly a behaving virtual function. As another example, a virtual function that consistently submits jobs larger than the expected video resolution of 1080p, such as 4 k resolution, is attempting to use an unfair share of the physical resources of the GPU 115. The job size monitor 320 identifies such a virtual function 210-213 as a badly-behaving virtual function. Virtual functions determined to be badly-behaving negatively impact the execution of jobs submitted by virtual functions that are determined to be well-behaving without intervention by the GPU 115.

Once the scheduler module circuitry 230 determines which of the virtual functions are badly-behaving and which are well-behaving, the scheduler module circuitry 230 implements multi-level scheduling to minimize the impact of the badly-behaving virtual functions on the well-behaving virtual functions, thereby improving quality of service (QOS) for the well-behaving virtual functions. In some embodiments, the scheduler module circuitry 230 maintains two lists, a first list for well-behaving virtual functions and a second list for badly-behaving virtual functions. The scheduler module circuitry 230 schedules well-behaving virtual functions from the first list when a virtual engine is idle. If there are no jobs pending for well-behaving virtual functions, the scheduler module circuitry 230 then schedules badly-behaving virtual functions. This allows configurable lenience towards a badly-behaving virtual function to accommodate more graceful handling of exceptional situations where at least one well-behaving virtual function may be behaving badly due to an exception. In some embodiments, the scheduler module circuitry 230 maintains more than two lists, categorizing virtual functions more finely than well-behaving and badly-behaving. For example, in some embodiments, the scheduler module circuitry 230 maintains lists for, e.g., very well-behaved virtual functions, very badly-behaved virtual functions, occasionally badly-behaved virtual functions, occasionally well-behaved virtual functions, etc.

In some embodiments, when a particular virtual function is on the badly-behaved list, the particular virtual function is not scheduled at all within a time period as a penalty. For example, if a virtual function overused its share in a past scheduling period, the virtual function must wait until the overuse is deducted from following scheduling periods, eventually being granted a time share again in a future period during which the virtual function may be rescheduled. In some embodiments, the classification of a virtual function as badly-behaved resets after the virtual function has been penalized, in order to provide tolerance for exceptional situations or changes in a use case at runtime. The timing and conditions of the classification reset are configurable. If a virtual function continues to be classified as badly-behaved for a longer time, the virtual function may eventually be prohibited from submitting jobs. In such a case, the scheduler module circuitry 230 bypasses submitting jobs for the badly-behaved virtual function during a current scheduling period.

The scheduling period is a sum of per-virtual function time partitions that are assigned to individual virtual functions. As shown in FIG. 5, a first scheduling period 510 is shown in which individual jobs submitted by the virtual machines further 220-223 are expected to execute. The first scheduling period 510 is followed by scheduling period 520, scheduling period 520 followed by scheduling period 530, and scheduling period 530 followed by scheduling period 540. Although four (4) scheduling periods are shown, such is shown for ease of explanation, with an understanding that the defined scheduling period continues to repeat as long as the virtual machines further 220-223 continue to submit jobs for execution.

In some embodiments, the scheduler module circuitry 230 adds an additional time or a slack time to the scheduling period. A purpose of slack time within a period is to absorb expected variance for submission behavior by different virtual functions that cannot be avoided for a use case. The slack time expands the size of the scheduling period such that jobs executing near the end of the scheduling period have time to execute past the scheduling period. The scheduler module circuitry 230 thereby prevents jobs that do not finish executing by an end of a scheduling period to be improperly categorized as badly-behaving, thereby providing flexibility to the scheduling period. As shown in FIG. 5, the first scheduling period 510 includes an additional slack time such that an additional time 519 remains after job 511 ends and before the end of the first scheduling period 510. As job 511 may not always start at the same time, and thereby end, within a scheduling period the additional time 519 provides flexibility for such instances to refrain from categorizing job 511 as badly-behaving. For example, if the job 511 is submitted near the end of the scheduling period, part of the job 511 may execute during the scheduling period and the remainder of the job 511 may execute during the next scheduling period. In such a case, the job 511 used only a portion of its allotted time in the scheduling period and has a surplus time that may carry forward to the next (i.e., subsequent) scheduling period. In some embodiments, the surplus time is not carried forward further than the next scheduling period, to prevent virtual functions from accumulating large surpluses.

Likewise, the second scheduling period 520 includes a slack time such that an additional time 529 remains after job 521 ends and before the end of the second scheduling period 520, the third scheduling period 530 includes a slack time such that an additional time 539 remains after job 531 ends and before an end of the third scheduling period 530, and the fourth scheduling period 540 includes a slack time such that an additional time 549 remains after job 541 ends and before an end of the fourth scheduling period 540.

As an example, the scheduler module circuitry 230 defines the slack time as 33.3 ms (two periods for 60 fps, i.e., 2*16.67 ms)−24 ms (expected used portion of 33.3 ms which is 4 VFs*3 ms*2 jobs per-VF within 33.3 ms). In some cases, a virtual function may not submit a job on time within 16.67 ms (e.g., job preparation is delayed), and instead submits 2 jobs in the next 16.67 ms (e.g., a virtual function is trying to catch up to still achieve 60 fps). As more variance between jobs is expected, n is made larger and/or the slack time is made larger. In some embodiments, the scheduler module circuitry 230 supports dynamic re-configuration of per-VF behaviors+algorithm parameters (e.g., slack, etc.).

In some embodiments, the scheduler module circuitry 230 can issue a single job size credit to at least one of the virtual functions 210-213. If any of the virtual functions 210-213 have >=job size unused (submit jobs that are smaller than the expected job size) within one of the scheduling periods 510-540, that particular one of the virtual functions 210-213 gets a single job size credit for the immediately following scheduling period during which the job size credit is assigned. For example, if virtual function 210 had >=job size unused within current scheduling period 510, the virtual function would get a single job size credit for the next scheduling period 520 relative to the current scheduling period 510. Thus, if a job for a particular virtual function is delayed, that particular virtual function is permitted to submit two jobs within the next scheduling period. In some embodiments, only a single job size credit is given to a particular virtual function to not cause undue disturbance to other virtual functions. In some embodiments, this job size credit is configurable as to how far the job size credit is carried forward (number of scheduling periods, e.g., 0 (job size credit is disabled), 1, 2, etc.).

In some embodiments, a well-behaving virtual function with remaining time within a particular scheduling period after completing the expected number of jobs within this particular scheduling period is given a one-time exception to run an additional job submitted within this particular scheduling period if the GPU is idle. This accommodates a scenario in which a well-behaving virtual function, having completed one or more jobs in a scheduling period, still has remaining time within the scheduling period which can be used to complete the job if granted the exception. In some embodiments, this one-off accommodation is not allowed in the next scheduling period or in the next X scheduling periods, where X is configurable, and if repeated, the virtual function is determined by the scheduler module circuitry 230 to be badly-behaving. In some embodiments, the exception is adjustable or may be disabled, depending on, e.g., GPU utilization within the scheduling period or recent history.

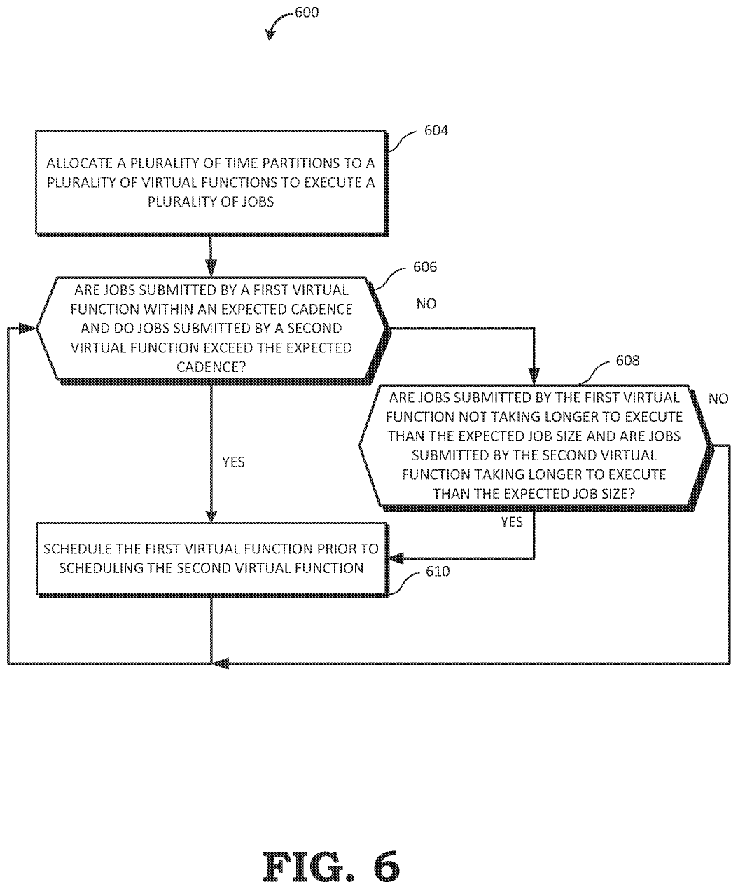

FIG. 6 is a flow diagram of a method 600 of scheduling first and second virtual functions of a plurality of virtual functions, in accordance with some embodiments. In some embodiments, method 600 is implemented by a processing system, such as the processing system 100 of FIG. 1. At block 604, a plurality of time partitions are allocated to a plurality of virtual functions to execute a plurality of jobs.

At block 606, the job cadence monitor 310 determines if a first plurality of jobs submitted by the first virtual function are within an expected cadence and a second plurality of jobs submitted by a second virtual function exceed the expected cadence. If, at block 606, the job cadence monitor 310 determines that the plurality of jobs 513, 514, 523, 524, 533, 534, 543, 544 submitted by the virtual function 212 exceed the expected cadence, and the job cadence monitor 310 determines that the plurality of jobs 511, 521, 531, 541 submitted by virtual function 210 are within the expected cadence and the plurality of jobs 512, 522, 532, 542 submitted by virtual function 211 are within the expected cadence, the method flow proceeds to block 610. If, at block 606, the job cadence monitor 310 determines that any of the jobs submitted by a particular virtual function do not exceed the expected cadence, block 606 of the method flow proceeds to block 608.

At block 608, the job size monitor 320 determines if a first plurality of jobs submitted by the first virtual function does not (or does) take longer to execute than an expected job size and if the second plurality of jobs submitted by the second virtual function takes (or do not take) longer to execute than the expected job size. With reference to FIGS. 3 and 5, the job size monitor 320 determines that the plurality of jobs 515, 525, 535, 545 submitted by the virtual function 213 take longer to execute than the expected job size, and the plurality of jobs 511, 521, 531, 541 submitted by virtual function 210 and the plurality of jobs 512, 522, 532, 542 submitted by the virtual function 211 do not take longer to execute than the expected job size. Although virtual function 212 is shown as submitting the jobs 513, 514, 523, 524, 533, 534, 543, 544 that exceed an expected cadence and virtual function 213 is shown as submitting the jobs 515, 525, 535, 545 that take longer to execute than an expected job size, such is shown for ease of explanation. In some embodiments, a virtual function (not shown) can submit jobs that are a combination of exceeding an expected cadence (e.g., a greater fps than expected) and taking longer to execute than an expected job size (e.g., a higher resolution than expected), and are scheduled according to being determined as a badly-behaving virtual function.

Note that the job size monitor 320 does not need to determine if the jobs 513, 514, 523, 524, 533, 534, 543, 544 submitted by the virtual function 212 take longer to execute than the expected job size as block 606 already determined that virtual function 212 is a badly-behaving virtual function, with appropriate corrective action taken by block 610 for virtual function 212. Should the job size monitor 320 determine that any of the jobs submitted by a particular virtual function take longer to execute than the expected job size, block 606 proceeds to block 610. Otherwise, should the job size monitor 320 determine that any of the jobs submitted by a particular virtual function do not take longer to execute than the expected job size, block 608 proceeds to block 606 such that method 600 continues to monitor for the expected cadence and the expected job size for the virtual functions 210-213 by blocks 606 and 608, respectively.

Although not shown, method 600 can end for one virtual function from a plurality of virtual functions and continue for the remaining virtual functions. For example, in the context of cloud gaming, a game that ceases to execute on a cloud gaming server will likewise result in the virtual functions 210-213 ceasing to submit jobs to the GPU 115. Therefore, method 600 will cease for that game but continue to execute for any remaining games executed by the GPU 115 that still receives jobs from the remaining ones of the virtual functions 210-213, and any newly added games, thereby continuing to determine if any virtual functions are submitting jobs exceeding an expected cadence and taking longer to execute than an expected job size. The method 600 can further include any of the functionality described above for the scheduler module circuitry 230, the job cadence monitor 310, and/or the job size monitor 320.

In some embodiments, the apparatus and techniques described above are implemented in a system including one or more integrated circuit (IC) devices (also referred to as integrated circuit packages or microchips), such as the processing system 100 described above with reference to FIGS. 1-6. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
allocating a plurality of time partitions within a scheduling period to a plurality of virtual functions for execution of jobs at a parallel processor, wherein the scheduling period includes a slack time to allow for variances in at least one of a cadence at which each virtual function submits jobs for execution and a size of jobs submitted for execution; and
preventing execution of jobs that exceed an allocated time partition for a virtual function of the plurality of virtual functions.

2. The method of claim 1, wherein preventing execution comprises:
scheduling a first virtual function to execute a first plurality of jobs after a second virtual function in response to submission of the first plurality of jobs exceeding an expected cadence and submission of a second plurality of jobs by the second virtual function not exceeding the expected cadence.

3. The method of claim 1, further comprising:
scheduling a first virtual function to execute a first plurality of jobs after a second virtual function in response to the first plurality of jobs exceeding an expected job size and a second plurality of jobs submitted by the second virtual function not exceeding the expected job size.

4. The method of claim 1, further comprising:
assigning a job size credit to a first virtual function if a size of jobs submitted by the first virtual function is smaller than an expected job size, wherein the job size credit can be used by the first virtual function in a subsequent scheduling period immediately following the scheduling period during which the job size credit is assigned.

5. The method of claim 1, further comprising:
maintaining a first level list and a second level list, the first level list including a first virtual function submitting a first plurality of jobs that are within an expected cadence and that do not take longer to execute than an expected job size, and the second level list including a second virtual function not included on the first level list; and
scheduling the first plurality of jobs for a virtual function in the first level list prior to scheduling a second plurality of jobs for a virtual function in the second level list.

6. The method of claim 5, further comprising:
bypassing scheduling the second plurality of jobs for the virtual function in the second level list within a current scheduling period.

7. The method of claim 1, wherein the scheduling period is a first scheduling period of a plurality of scheduling periods, the method further comprising:
scheduling a first virtual function after a second virtual function if a first number of a first plurality of jobs submitted by the first virtual function within the plurality of scheduling periods is more than a second number of a second plurality of jobs submitted by the second virtual function within the plurality of scheduling periods.

8. The method of claim 1, further comprising:
allowing a virtual function with remaining time within an allocated time partition and not having completed a job within the scheduling period to submit the job if the parallel processor is idle.

9. A processing system, comprising:
a parallel processor; and
scheduler module circuitry configured to:
allocate a plurality of time partitions within a scheduling period to a plurality of virtual functions for execution of jobs at the parallel processor, wherein the scheduling period includes a slack time to allow for variances in at least one of a cadence at which each virtual function submits jobs for execution and a size of jobs submitted for execution; and
prevent execution of jobs that exceed an allocated time partition for a first virtual function of the plurality of virtual functions.

10. The processing system of claim 9, wherein the scheduler module circuitry is further configured to:
schedule the first virtual function after a second virtual function in response to submission of a first plurality of jobs by the first virtual function exceeding an expected cadence and submission of a second plurality of jobs by the second virtual function not exceeding the expected cadence.

11. The processing system of claim 9, wherein the scheduler module circuitry is further configured to:
schedule the first virtual function after a second virtual function in response to a first plurality of jobs submitted by the first virtual function exceeding an expected job size and a second plurality of jobs submitted by the second virtual function not exceeding the expected job size.

12. The processing system of claim 9, wherein the scheduler module circuitry is further configured to:
assign a job size credit to a virtual function if a size of jobs submitted by the virtual function is smaller than an expected job size, wherein the job size credit can be used by the virtual function in a subsequent scheduling period immediately following the scheduling period during which the job size credit is assigned.

13. The processing system of claim 9, wherein the scheduler module circuitry is further configured to:
maintain a first level list and a second level list, the first level list including the first virtual function submitting a first plurality of jobs that are within an expected cadence and that do not take longer to execute than an expected job size, and the second level list including a second virtual function not included on the first level list; and
schedule the first plurality of jobs for a virtual function in the first level list prior to scheduling a second plurality of jobs for a virtual function in the second level list.

14. The processing system of claim 13, wherein the scheduler module circuitry is further configured to:
bypass scheduling the second plurality of jobs for the second virtual function within a current scheduling period.

15. The processing system of claim 9, wherein the scheduling period is a first scheduling period of a plurality of scheduling periods, the scheduler module circuitry is further configured to:
schedule the first virtual function after a second virtual function if a first number of a first plurality of jobs submitted by the first virtual function within the plurality of scheduling periods is more than a second number of a second plurality of jobs submitted by the second virtual function within the plurality of scheduling periods.

16. The processing system of claim 9, the scheduler module circuitry is further configured to:
allow a virtual function with remaining time within an allocated time partition and not having completed a job within the scheduling period to submit the job if the parallel processor is idle.

17. A server, comprising:
a parallel processor configured to execute jobs submitted by a plurality of virtual functions; and
scheduler module circuitry configured to:
allocate a time partition to each of the plurality of virtual functions within a scheduling period based on an expected job size and cadence and a slack time to allow for variances in submitted job sizes and cadences; and
prevent execution at the parallel processor of jobs that exceed an allocated time partition for a virtual function of the plurality of virtual functions.

18. The server of claim 17, wherein the scheduler module circuitry is further configured to:
schedule a first virtual function prior to a second virtual function in response to a first plurality of jobs submitted by the first virtual function having a frequency below an expected cadence and a second plurality of jobs submitted by the second virtual function exceeding the expected cadence.

19. The server of claim 17, wherein the scheduler module circuitry is further configured to:
schedule a first virtual function prior to a second virtual function in response to a first plurality of jobs submitted by the first virtual function not exceeding an expected job size and a second plurality of jobs submitted by the second virtual function exceeding the expected job size.

20. The server of claim 17, wherein the scheduler module circuitry is further configured to:
maintain a first level list and a second level list, the first level list including a first virtual function submitting a first plurality of jobs that are within an expected cadence and that do not take longer to execute than an expected job size and the second level list including a second virtual function not included on the first level list; and
schedule the first plurality of jobs for the first virtual function in the first level list prior to scheduling a second plurality of jobs for the second virtual function in the second level list.
